(19) United States
(12) Patent Application Publication
(10) Pub. No.: US 2026/0047736 A1
(43) Pub. Date: Feb. 19, 2026

(54) CLEANING ROBOT CAPABLE OF RECOGNIZING FLOOR TYPE

(71) Applicant: PIXART IMAGING INC., Hsin-Chu County (TW)

(72) Inventors: Guo-Zhen WANG, Hsin-Chu County (TW); Mian-Jhong CHIU, Hsin-Chu County (TW)

(21) Appl. No.: 19/209,795

(22) Filed: May 16, 2025

Related U.S. Application Data
(63) Continuation-in-part of application No. 18/801,760, filed on Aug. 13, 2024.

(51) Int. Cl. A47L 9/28; A47L 11/40; G05D 1/242; G05D 105/10

(52) U.S. Cl. CPC A47L 9/2826; A47L 9/2852; A47L 11/4002; A47L 11/4011; G05D 1/242; A47L 2201/04; A47L 2201/06; G05D 2105/10

(57) ABSTRACT

There is provided a cleaning robot including an image sensor, a first light source, a second light source and a processor. The image sensor captures has a field of view. The first light source emits light with a first emission angle, which covers the whole of the field of view within a detectable range. The second light sources emits light with a second emission angle, which overlaps with the field of view at different heights in the detectable range by different cross sections. The processor performs surface tracking according to image frames captured by the image sensor upon the first light source being turned on, and recognizes a type of a working surface upon the second light source being turned on.

### CROSS REFERENCE TO RELATED APPLICATION

The present application is a continuation-in-part application of U.S. patent application Ser. No. 18/801,760 filed on, Aug. 13, 2024, the disclosure of which is hereby incorporated by reference herein in its entirety.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

### FIELD OF THE DISCLOSURE

This disclosure generally relates to a cleaning robot and, more particularly, to a cleaning robot and a floor type recognition method that are able to recognize a flat floor, a carpet with short hairs and a carpet with long hairs.

### BACKGROUND OF THE DISCLOSURE

The cleaning robot has been improved from having the conventional sweeping function to having a mopping function. Accordingly, as long as a cleaning robot is able to accurately distinguish the floor type, it is possible to adjust a corresponding suction force, to remove a wiping component and to adjust a height of the wiping component.

For example, while operating on a flat floor, the cleaning robot operates in a normal suction force. However, while running on a carpet, the cleaning robot increases the suction force in order to have a better cleaning performance, and in the meantime the height of a wiping component is increased or the wiping component is automatically removed from the main body.

Nowadays, there are some products that use ultrasonics to recognize a carpet and a flat floor. However, due to the physical limitation of the ultrasonics, it is not able to accurately distinguish a carpet with short hairs from a flat floor. In addition, the cleaning robot is further required to recognize a carpet with long hairs in some scenarios. If a carpet type cannot be recognized, some functions of the cleaning robot cannot be operated normally.

The information disclosed in this BACKGROUND is merely intended to increase understanding of the general background of the invention and should not be taken as an admission or in any way implied that the relevant information constitutes prior art that is already known to a person of ordinary skill in the art.

### SUMMARY

Accordingly, the present disclosure provides a cleaning robot and a floor type recognition method thereof that use different detecting means to recognize a flat floor, a carpet with short hairs and a carpet with long hairs.

The present disclosure further provides a cleaning robot and a floor type recognition method thereof that use a dark field effect to recognize a flat floor and a carpet with short hairs, and use multiple light sources or multiple light sensors to identify a carpet with long hairs.

The present disclosure provides a cleaning robot for being operated on a working surface and including an image sensor, a first light source, a second light source and a processor. The image sensor has a field of view. The first light source is configured to illuminate light with a first emission angle, which covers the whole of the field of view within a predetermined detectable range of the image sensor. The second light source is configured to illuminate light with a second emission angle, which overlaps with the field of view of the image sensor by different cross sections at different heights in the predetermined detectable range. The processor is configured to recognize a type of the working surface according to a beam area of the second light source in an image frame captured by the image sensor. The field of view of the image sensor is tilted toward the second light source to cause the second emission angle to overlap with the field of view of the image sensor by different cross sections at the different heights.

The present disclosure further provides a cleaning robot for being operated on a working surface and including an image sensor, a first light source, a second light source and a processor. The image sensor has a field of view. The first light source is configured to illuminate light with a first emission angle, which covers the whole of the field of view within a predetermined detectable range of the image sensor. The second light source is configured to illuminate light with a second emission angle, which overlaps with the field of view of the image sensor by different cross sections at different heights in the predetermined detectable range. The processor is configured to recognize a type of the working surface according to a beam area of the second light source in an image frame captured by the image sensor. The field of view of the image sensor is directed perpendicular to the working surface, and the second emission angle is tilted toward the image sensor.

The present disclosure further provides a cleaning robot for being operated on a working surface and including an image sensor, a first light source, a second light source and a processor. The image sensor has a field of view. The first light source is configured to illuminate light with a first emission angle, which covers the whole of the field of view within a predetermined detectable range of the image sensor. The second light source is configured to illuminate light with a second emission angle, which overlaps with the field of view of the image sensor by different cross sections at different heights in the predetermined detectable range. The processor is configured to perform surface navigation according to first image frames captured by the image sensor upon the first light source emitting the light, and identify the working surface at different heights, due to the cleaning robot operating on different types of the working surface, according to a variation of a beam area in an image frame captured by the second image sensor upon the second light source emitting the light.

### BRIEF DESCRIPTION OF DRAWINGS

Other objects, advantages, and novel features of the present disclosure will become more apparent from the following detailed description when taken in conjunction with the accompanying drawings.

FIG. 1A is a schematic diagram of lighting a first light source of a cleaning robot according to a first embodiment of the present disclosure.

FIG. 1B is a schematic diagram of lighting a second light source of a cleaning robot according to a first embodiment of the present disclosure.

FIG. 2A is a descriptive table of a floor type recognition method of a cleaning robot according to a first embodiment of the present disclosure.

FIG. 2B is a schematic diagram of light section images in an image frame acquired by a cleaning robot according to a first embodiment of the present disclosure.

FIG. 3 is a schematic diagram of a cleaning robot according to a second embodiment of the present disclosure.

FIG. 4A is a schematic diagram of lighting a first light source of a cleaning robot according to a third embodiment of the present disclosure.

FIG. 4B is a schematic diagram of lighting a second light source of a cleaning robot according to a third embodiment of the present disclosure.

FIG. 5 is a schematic diagram of arranging a first light source on a bottom cover of a cleaning robot according to an embodiment of the present disclosure.

FIG. 6 is a bottom view of a cleaning robot according to an embodiment of the present disclosure.

FIG. 7A is a schematic diagram of lighting a first light source of a cleaning robot according to a fourth embodiment of the present disclosure.

FIG. 7B is a schematic diagram of lighting a second light source of a cleaning robot according to a fourth embodiment of the present disclosure.

FIG. 8 is a schematic diagram of beam areas captured at different heights by an image sensor of a cleaning robot according to a fourth embodiment of the present disclosure.

FIG. 9 is a schematic diagram of a cleaning robot according to a fifth embodiment of the present disclosure.

FIG. 10 is a schematic diagram of a cleaning robot according to a sixth embodiment of the present disclosure.

### DETAILED DESCRIPTION OF THE DISCLOSURE

It should be noted that, wherever possible, the same reference numbers will be used throughout the drawings to refer to the same or like parts.

One objective of the present disclosure is to provide a cleaning robot capable of recognizing a flat floor (e.g., including a ceramic tile floor, a wood floor and a marble floor, but not limited to), a carpet with short hairs and a carpet with long hairs by arranging multiple light sources or multiple light sensors. In this way, the cleaning robot is able to execute different cleaning functions corresponding to different types of a working surface, and these cleaning functions are determined according to the equipped devices thereof without particular limitations. For example, after receiving an identification result made by a processor 13 (described below) of a sensor chip/module of the present disclosure, the micro controller unit (MCU) or a central processing unit (CPU) of the cleaning robot controls the cleaning robot to perform corresponding functions.

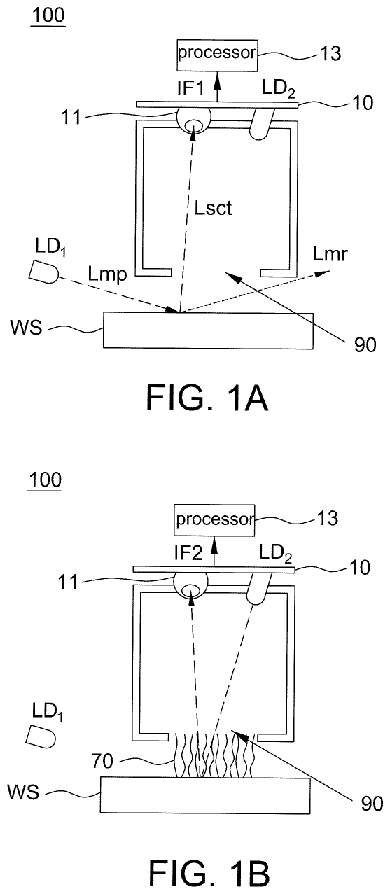

Please refer to FIGS. 1A and 1B, FIG. 1A is a schematic diagram of lighting a first light source LD1 of a cleaning robot 100 according to a first embodiment of the present disclosure; and FIG. 1B is a schematic diagram of lighting a second light source LD2 of a cleaning robot 100 according to a first embodiment of the present disclosure. The cleaning robot 100 is able to recognize a type of a working surface Ws on which the cleaning robot 100 operates.

The cleaning robot 100 includes a first light source LD1, a second light source LD2, a substrate 10, an image sensor 11 and a processor 13.

The first light source LD1 is used to illuminate the working surface WS using a main projection light beam Lmp to form a main reflected light beam Lmr, wherein the main projection light beam Lmp and the main reflected light beam Lmr are light beams symmetrical to a normal line of the working surface WS.

The second light source LD2 is used to project a linear light section toward the working surface WS. For example, the second light source LD2 includes a laser light source and a diffractive optical element (DOE), which causes emission light emitted by the laser light source to generate the linear light section after passing therethrough.

The substrate 10 is, for example, a printed circuit board (PCB) or a flexible board without particular limitations. In one aspect, the second light source LD2 and the image sensor 11 are disposed on the substrate 10, but not limited to.

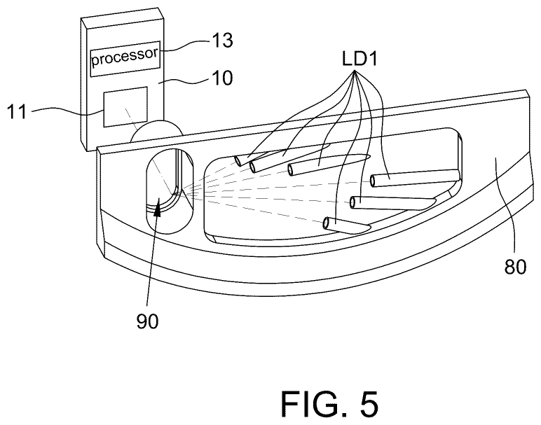

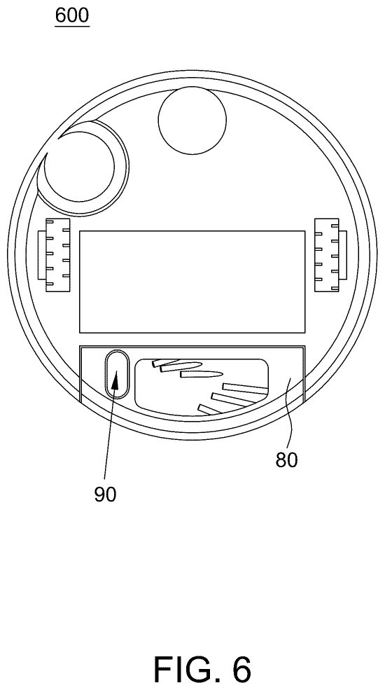

The cleaning robot 100 further includes a bottom cover 80 (e.g., referring to FIG. 5), which is attached to a bottom of the cleaning robot 100, e.g., referring to FIG. 6. The bottom cover 80 is arranged, for example, at a side of the cleaning robot 100 close to a moving direction of the cleaning robot 100 such that the cleaning robot 100 firstly detects a type of the working surface WS before a cleaning device (e.g., sweeping and wiping components) thereof enters a different working surface. In one aspect, the first light source LD1 is arranged on the bottom cover 80.

In one aspect, the bottom cover 80 includes a through hole 90 and a bottom surface connecting to the through hole 90. The substrate 10 is arranged inside the through hole 90 (e.g., referring to FIG. 5) to allow the second light source LD2 to project the linear light section to the working surface WS via the through hole 90 and allow the image sensor 11 to receive scattered light Lsct of the main projection light beam Lmp illuminating the working surface WS and to capture reflected light of the linear light section. The first light source LD1 is arranged on the bottom surface outside the through hole 90. As shown in FIG. 5, the first light source LD1 may be arranged at different positions from the through hole 90. It should be mentioned that the multiple first light sources LD1 shown in FIG. 5 are to indicate that the first light source LD1 may be arranged at different positions but not to indicate that the cleaning robot 100 includes multiple first light source LD1. In the present disclosure, the cleaning robot 100 may include a single first light source LD1.

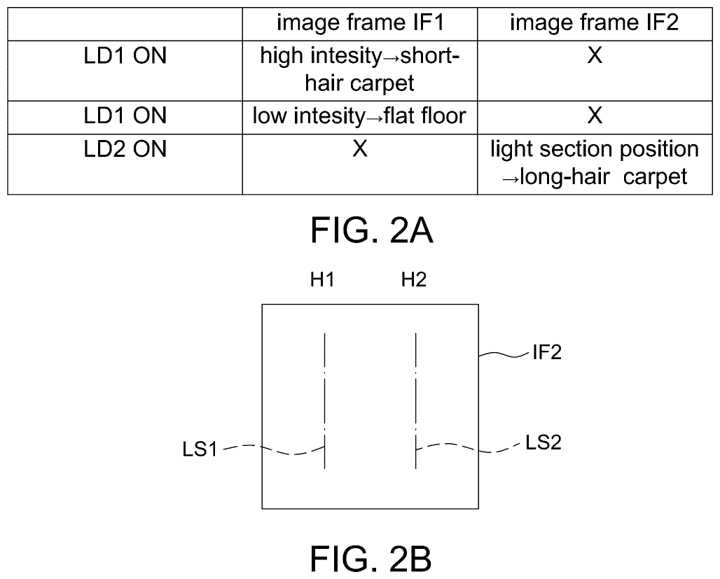

The image sensor 11 is, for example, complementary metal-oxide-semiconductor (CMOS) image sensor or a charge-coupled device (CCD) image sensor. In the present disclosure, the image sensor 11 is not arranged on the main reflected light beam Lmr of the first light source LD1 so as to perform the detection based on the dark field effect. The image sensor 11 receives the scattered light Lsct generated from the working surface WS when the working surface WS is illuminated by the main projection light beam Lmp of the first light source LD1 to output a first image frame IF1, and acquires a second image frame IF2 containing a light section image (e.g., LS1 and LS2 shown in FIG. 2B) of the linear light section of the second light source LD2.

The processor 13 is a digital signal processor (DSP), an application specific integrated circuit (ASIC) or a field programmable gate array (FPGA). The processor 13 is coupled to the first light source LD1 and the second light source LD2 to control ON/OFF thereof, and is coupled to the image sensor 11 to receive the first image frame IF1 and the second image frame IF2. In the first embodiment, the processor 13 recognizes the working surface WS as a flat floor or a carpet with short hairs according to the first image frame IF1, and recognizes whether the working surface WS is a carpet with long hairs or not according to the second image frame IF2, e.g., the carpet with long hairs being identified when a length of hairs 70 (referring to FIG. 1B) of a carpet is longer than a predetermined length. In one aspect, the processor 13 further outputs the detected length of hairs 70 to the MCU or CPU of the cleaning robot 100 for corresponding controls/processes. The processor 13 implements operations thereof using hardware, firmware and/or software.

For example referring to FIG. 2A, the processor 13 identifies that the working surface WS is a carpet with short hairs when an average brightness of the first image frame IF1 exceeds a brightness threshold (e.g., shown as high intensity), and identifies that the working surface WS is a flat floor when the average brightness of the first image frame IF1 is lower than the brightness threshold (e.g., shown as low intensity).

The cleaning robot 100 further includes, for example, a memory (not shown) that records the relationship between different positions of the light section image in the second image frame IF2 with respect to different distances. For example referring to FIG. 2B, a light section image LS1 is corresponding to a first height H1 (or first hair length) of the working surface WS, and a light section image LS2 is corresponding to a second height H2 (or second hair length) of the working surface WS. The processor 13 obtains a current distance from the working surface WS according to a current position of the light section (e.g., positions of LS1 or LS2) and the relationship (i.e. using triangulation ranging) to identify whether the working surface WS is a carpet with long hairs or not. To use the triangulation ranging, the second light source LD2 preferably projects the linear light section with a tilted angle with respect to the normal line of the working surface WS.

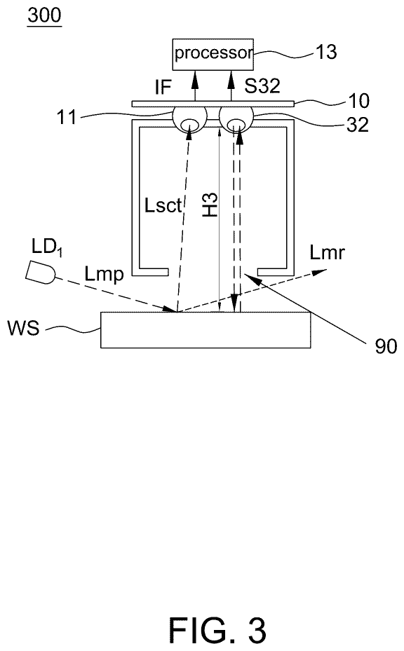

Please refer to FIG. 3, it is a schematic diagram of a cleaning robot 300 according to a second embodiment of the present disclosure. The cleaning robot 300 is also able to recognize a type of a working surface WS on which the cleaning robot 300 operates. The cleaning robot 300 also includes a light source LD1, a substrate 10, an image sensor 11 and a processor 13, which are respectively identical to those in the first embodiment having identical reference numerals. In the second embodiment, the light source LD1 is used to illuminate the working surface WS using a main projection light beam Lmp to form a main reflected light beam Lmr. The image sensor 11 is not arranged on the main reflected light beam Lmr, and is used to receive scattered light Lsct generated by the main projection light beam Lmp illuminating the working surface WS to output an image frame IF. The image sensor 11 is arranged on the substrate 10 and the light source LD1 is arranged on the bottom cover 80, which are identical to the first embodiment and thus details thereof are not repeated herein.

The difference between the second embodiment and the first embodiment is that the second embodiment further includes a time-of-flight (ToF) sensor 32 for measuring a distance from the working surface WS to replace the second light source LD2. The Tof sensor 32 is, for example, a single photon avalanche diode (SPAD) based direct ToF sensor or indirect ToF sensor without particular limitations. The method to measure a distance by the time-of-flight is known to the art, and thus details thereof are not described herein. In one aspect, the ToF sensor 32 and the image sensor 11 are arranged on the substrate 10, and are opposite to the working surface WS via a through whole 90. In the second embodiment, the ToF sensor 32 and the image sensor 11 operate simultaneously or time-divisionally without particular limitations.

In the second embodiment, the processor 13 recognizes the working surface WS as a flat floor or a carpet with short hairs according to the image frame IF, which is identical to that described in the first embodiment (e.g., referring to FIG. 2A), and thus details thereof are not repeated herein. The processor 13 further identifies that the working surface WS as a carpet with long hairs when a distance H3 detected by the ToF sensor 32 is smaller than a distance threshold, which means the carpet hairs enter the through hole 90.

In one aspect, the processor 13 further outputs the distance H3 measured by the ToF sensor 32 to the MCU or CPU of the cleaning robot 300 for corresponding controls/processes.

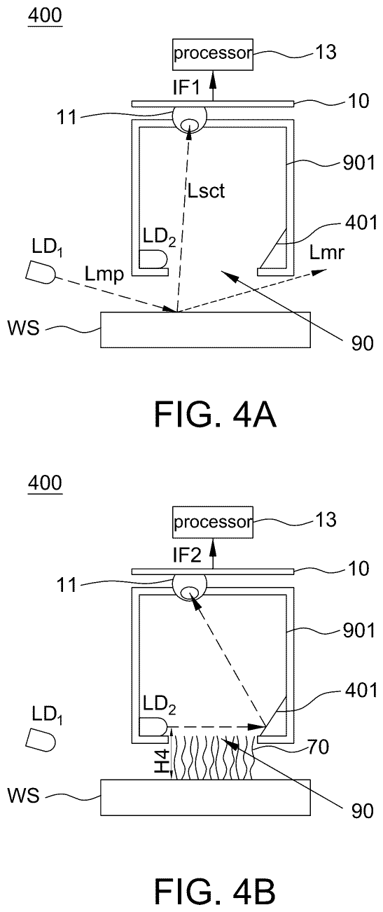

Please refer to FIGS. 4A and 4B, FIG. 4A is a schematic diagram of lighting a first light source LD1 of a cleaning robot 400 according to a third embodiment of the present disclosure; and FIG. 4B is a schematic diagram of lighting a second light source LD2 of a cleaning robot 400 according to a third embodiment of the present disclosure. The cleaning robot 400 is also able to recognize a type of a working surface WS on which the working surface WS operates.

The cleaning robot 400 also includes a first light source LD1, a second light source LD2, a substrate 10, an image sensor 11 and a processor 13. The difference between the third embodiment and the first embodiment is that the second light source LD2 is arranged at a different position in the third embodiment, and the second light source LD2 projects a linear light source or not without particular limitations.

Similarly, the first light source LD1 is used to illuminate the working surface WS using a main projection light beam Lmp to form a main reflected light beam Lmr. The image sensor 11 is not arranged on the main reflected light beam Lmr, and is used to receive scattered light Lsct of the main projection light beam Lmp illuminating the working surface WS to output a first image frame IF1.

The second light source LD2 is used to illuminate a reflection surface 401 toward a direction parallel to the working surface WS, e.g., a transverse direction as shown in FIG. 4B. The image sensor 11 further receives reflected light of the reflection surface 401 that reflects an emission light beam of the second light source LD2 to output a second image frame IF2.

In the third embodiment, the first light source LD1 is arranged on a bottom surface outside the through hole 90, referring to FIGS. 5 and 6. The second light source LD2 is arranged at a first side on an inner wall 901 of the through hole 90 (e.g., at a height H4), and the reflection surface 401 is arranged at a second side, opposite to the first side, on the inner wall 901 of the through hole 90. The reflection surface 401 is arranged with a tilted angle to reflect an optical path of the second light source LD2 toward the image sensor 11.

The substrate 100 is arranged inside the through hole 90. The image sensor 11 is arranged on the substrate 10, but the second light source LD2 is not arranged on the substrate 10.

In the third embodiment, the processor 13 recognizes the working surface WS as a flat floor or a carpet with short hairs according to the first image frame IF1, which has been illustrated in the first embodiment (e.g., referring to FIG. 2A) and thus details thereof are not described again.

The processor 13 further recognizes whether the working surface WS is a carpet with long hairs. For example, when carpet hairs 70 block a transverse optical path of the second light source LD2, the image sensor 11 is not able to receive light energy from the reflection surface 401. Therefore, the third embodiment is arranged in the way that when an average brightness of the second image frame IF2 is lower than a brightness threshold, the processor 13 identifies the working surface Ws as a carpet with long hairs, indicating the optical path of the second light source LD2 being blocked. The length of carpet hairs to distinguish a carpet with long hairs is defined by a height (e.g., H4) of the second light source LDs being arranged.

The third embodiment may be combined with the second embodiment to form an alternative embodiment. For example, the LD2 in FIGS. 4A and 4B is replaced by the ToF sensor 32 to measure a distance from another side of the inner wall 901 of the through hole 90, i.e. the reflection surface 401 being removed. When the carpet hairs 70 are longer than the height H4, the ToF sensor 32 measures a shorter distance and thus a carpet with long hairs is recognized.

In another alternative embodiment, the LD2 in FIGS. 4A and 4B is arranged above the reflection surface 401 (e.g., arranged on the substrate 10 with the image sensor 11), and the position originally arranged with the LD2 is replaced by another reflection surface such that a projection light beam from the LD2 arranged above the reflection surface 401 is received by the image sensor 11 after being reflected twice. That is, this alternative embodiment is to form a transverse light beam between two reflection surfaces at a height H4 for detecting whether the carpet hairs 70 enter the through hole 90 or not.

In another alternative embodiment, the LD2 in FIGS. 4A and 4B is arranged to project a longitudinal (i.e. extending direction of hairs) linear light section on the inner wall 901 (without reflection surface 401), and a field of view of the image sensor 11 covers the longitudinal light section. In this way, the processor 13 identifies a length of carpet hairs 70 and recognizes a carpet with long hairs according to a length variation of a light section image of the longitudinal light section in the second image frame IF2. The processor 13 may output the detected length signal to the MCU or CPU of the cleaning robot for corresponding controls/processes.

It should be mentioned that although the drawings of the present disclosure show light sources by LD1 and LD2, the light sources of the present disclosure are not limited to laser diodes. The light sources of the present disclosure may be light emitting diodes (LED).

In the above embodiments, the light source LD1 is not arranged together with the light source LD2 at the same substrate such that it is difficult to include the two light sources in a small module. The present disclosure further provides a cleaning robot with an optical engine (e.g., including light sources and image sensor) formed as one module and also being able to recognize a type (e.g., a flat floor, a carpet with short hairs or long hairs mentioned above) of a working surface WS on which the cleaning robot operates.

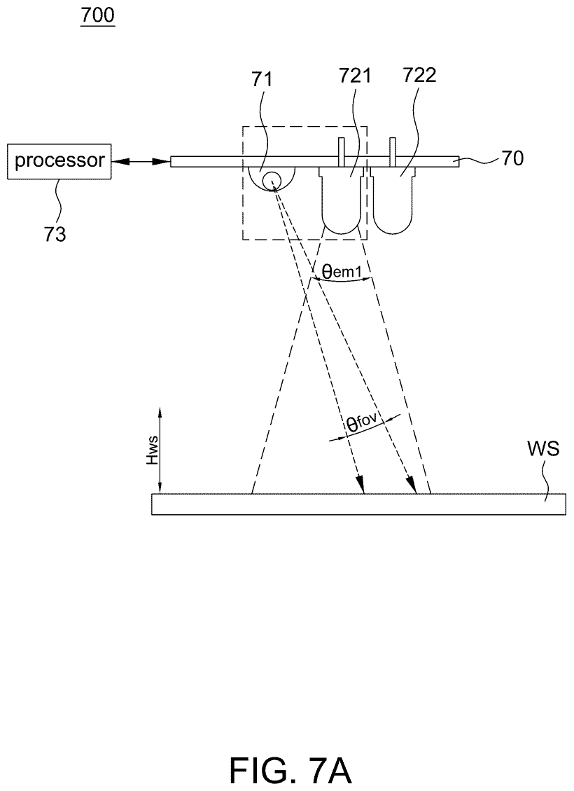

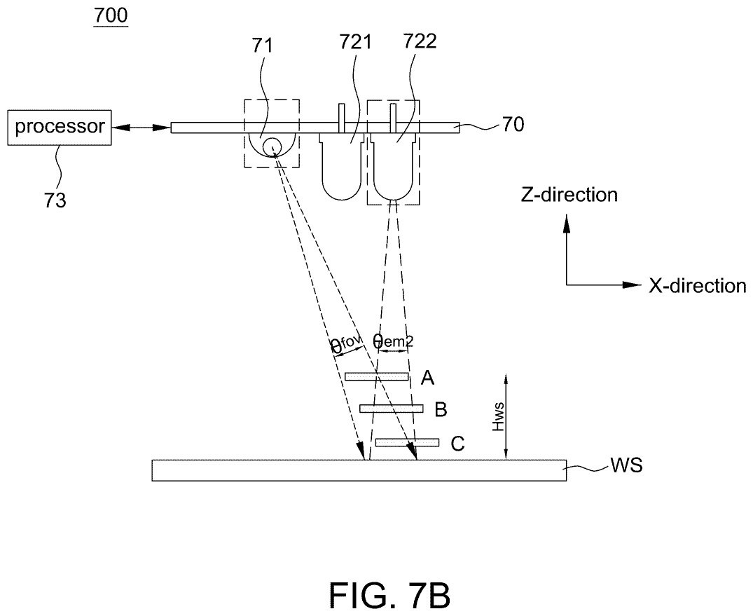

Please refer to FIGS. 7A and 7B, FIG. 7A is a schematic diagram of lighting a first light source 721 and enabling an image sensor 71 of a cleaning robot 700 according to a fourth embodiment of the present disclosure; and FIG. 7B is a schematic diagram of lighting a second light source 722 and enabling an image sensor 71 of a cleaning robot 700 according to a fourth embodiment of the present disclosure.

The cleaning robot 700 includes a substrate 70, an image sensor 71, a first light source 721, a second light source 722 and a processor 73. In one aspect, the substrate 70 is identical to the substrate 10 mentioned above. The image sensor 71, the first light source 721 and the second light source 722 are arranged on the substrate 70.

The image sensor 71 is identical to the image sensor 11 as mentioned above. The image sensor 71 has a field of view θfov.

In one aspect, the first light source 721 is a light emitting diode (LED), and illuminates light with a first emission angle θem1. The second light source 722 is a light emitting diode, and illuminates light with a second emission angle θem2. In another aspect, the second light source 722 is a laser diode (LD). Preferably, the second emission angle θem2 is arranged to be smaller than the first emission angle θem1.

In the aspect that the first light source 721 and the second light source 722 are both LEDs, the first light source 721 and the second light source 722 emit light alternatively, i.e. not at the same time. In the aspect that the second light source 722 is a laser diode, the first light source 721 and the second light source 722 may emit light alternatively or simultaneously.

In the present disclosure, the first emission angle θem1 is arranged to cover the whole of the field of view θfov within a predetermined detectable range Hws of the image sensor 71. The predetermined detectable range Hws is determined according to, for example, circuit parameters of the image sensor 71, operating environment (e.g., a length of hairs/fleeces of carpet) of the cleaning robot 700 and spatial relationship between components of the optical engine.

Meanwhile, the second emission angle θem2 is arranged to overlap with the field of view θfov of the image sensor 71 by different cross sections at different heights in the predetermined detectable range Hws, e.g., FIGS. 7A and 7B showing a first height (or first height threshold) A, a second height (or second height threshold) B and a third height (or third height threshold) C, wherein the first height A is higher than the second height B, and the second height B is higher than the third height C.

In one aspect, an operation distance of A (between the substrate 70 and a plane A) is between 3 cm to 3.8 cm corresponding to a length (e.g., 1.2 cm to 2 cm) of hairs of a carpet with long hairs; an operation distance of B (between the substrate 70 and a plane B) is between 4 cm to 4.4 cm corresponding to a length (e.g., 0.6 cm to 1 cm) of hairs of a carpet with short hairs; and an operation distance of C (between the substrate 70 and a plane C) is about 5 cm corresponding to a flat floor. It is appreciated that the predetermined detectable range Hws is determined according to a length of hairs of a carpet to be detected without particular limitations.

It should be mentioned that although the plane C in FIG. 7B is shown to be separated from the working surface WS, it is only intended to illustrate but not to limit the present disclosure. In another aspect, the plane C is identical to the working surface WS.

In the fourth embodiment of the present disclosure shown in FIGS. 7A and 7B, the field of view θfov of the image sensor 71 is tilted toward the second light source 722 to cause the second emission angle θem2 to overlap with the field of view θfov of the image sensor 71 by different cross sections at said different heights.

It should be mentioned that although FIGS. 7A and 7B show that the first light source 721 and the second light source 722 are at the same side (e.g., right side) of the image sensor 71, the present disclosure is not limited thereto. The first light source 721 in FIGS. 7A-7B is shown to be closer to the image sensor 71 than the second light source 722 in a tilted direction (e.g., X-direction or left-right direction shown in FIG. 7B) of the field of view θfov of the image sensor 71.

In another aspect, the first light source 721 and the second light source 722 are at different sides (e.g., one at right side and the other at left side) of the image sensor 71 as long as the requirements of the field of view θfov and the emission angles θem1 and θem2 mentioned above are fulfilled.

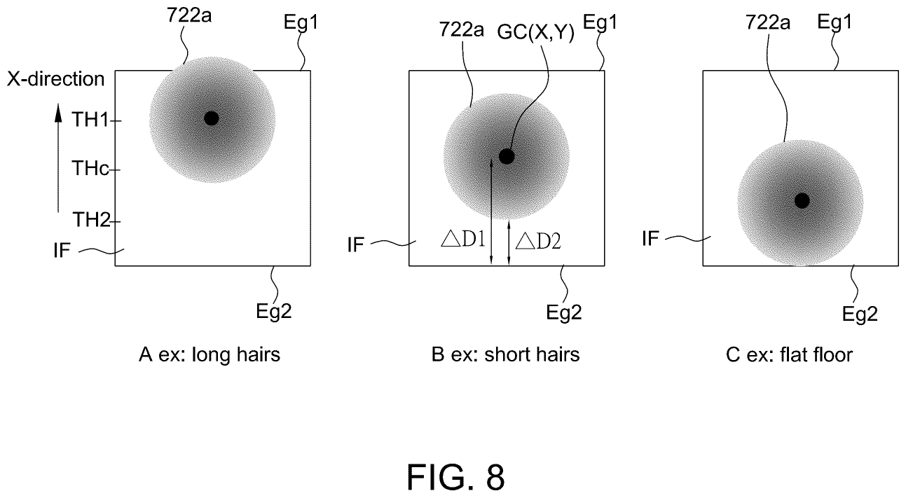

The processor 73 is coupled to the image sensor 71, the first light source 721 and the second light source 722 via the substrate 70. The processor 73 is used to recognize a type of the working surface WS according to a beam area of the second light source 722 in an image frame captured by the image sensor 71. Referring to FIG. 8, it is a schematic diagram of beam areas 722a corresponding to different heights (e.g., heights A, B and C) in an image frame IF captured by an image sensor 71 of a cleaning robot 700 according to a fourth embodiment of the present disclosure. That is, the second light source 722 is used to detect a type of the working surface WS herein.

In one aspect, the processor 73 recognizes a flat floor, a carpet with short hairs and a carpet with long hairs according to a gravity center position (e.g., shown as GC in FIG. 8) of the beam area 722a in the image frame IF along a tilted direction (e.g., X-direction in FIGS. 7B and 8) of the field of view θfov of the image sensor 71. For example, when the gravity center position GC is between TH1 and THc in FIG. 8, indicating that a height of the working surface WS is between the heights A and B in FIG. 7B, the processor 73 recognizes that the working surface WS is a carpet with long hairs; when the gravity center position GC is between THc and TH2 in FIG. 8, indicating that a height of the working surface WS is between the heights B and C in FIG. 7B, the processor 73 recognizes that the working surface WS is a carpet with short hairs; and when the gravity center position GC is between TH2 and an edge Eg2 of the image frame IF in FIG. 8, indicating that a height of the working surface WS is lower than the height C in FIG. 7B, the processor 73 recognizes that the working surface WS is a flat floor.

The values of A, B and C are previously determined before shipment according to different applications. For example in another aspect, the cleaning robot 700 is arranged with two height thresholds, e.g., A and B (or TH1 and THc). In this aspect, when the gravity center position GC is between TH1 and an edge Eg1 of the image frame IF in FIG. 8, indicating that a height of the working surface WS is higher than the height A in FIG. 7B, the processor 73 recognizes that the working surface WS is a carpet with long hairs; when the gravity center position GC is between TH1 and THc in FIG. 8, indicating that a height of the working surface WS is between the heights A and B in FIG. 7B, the processor 73 recognizes that the working surface WS is a carpet with short hairs; and when the gravity center position GC is between THc and an edge Eg2 of the image frame IF in FIG. 8, indicating that a height of the working surface WS is lower than the height B in FIG. 7B, the processor 73 recognizes that the working surface WS is a flat floor.

In another aspect, the processor 73 recognize a flat floor, a carpet with short hairs and a carpet with long hairs according to a distance (e.g., ΔD1 or ΔD2 shown in FIG. 8) of the beam area 722a from an edge EG2 of the image frame IF in a tilted direction of the field of view θfov of the image sensor 71. Similarly, the processor 73 compares the distance ΔD1 or ΔD2 with more than one predetermined threshold (e.g., the number of thresholds being determined according to a number of types of working surface WS desired to be recognized or distinguished) so as to identify a type of working surface WS. The comparison processor is similar to those describes in paragraphs [0071] and [0072] only changing a position of GC=(X, Y) to ΔD1 or ΔD2, and thus details thereof are not repeated herein.

Besides, the processor 73 further performs surface navigation according to image frames captured by the image sensor 71 upon the first light source 721 emitting the light. That is, the first light source 721 is used for surface navigation. The surface navigation includes calculating displacement and moving direction (e.g., by comparing two image frames) of the cleaning robot 700 with respect to the working surfaces WS. The method of calculating displacement and moving direction is known to the art, e.g., calculating correlation between two image frames, and thus details thereof are not described herein.

In the fourth embodiment, the field of view θfov is tilted and the emission angle θem2 is perpendicular to a surface of the substrate 70 or perpendicular to a surface of the working surface WS, e.g., directed in a Z-direction.

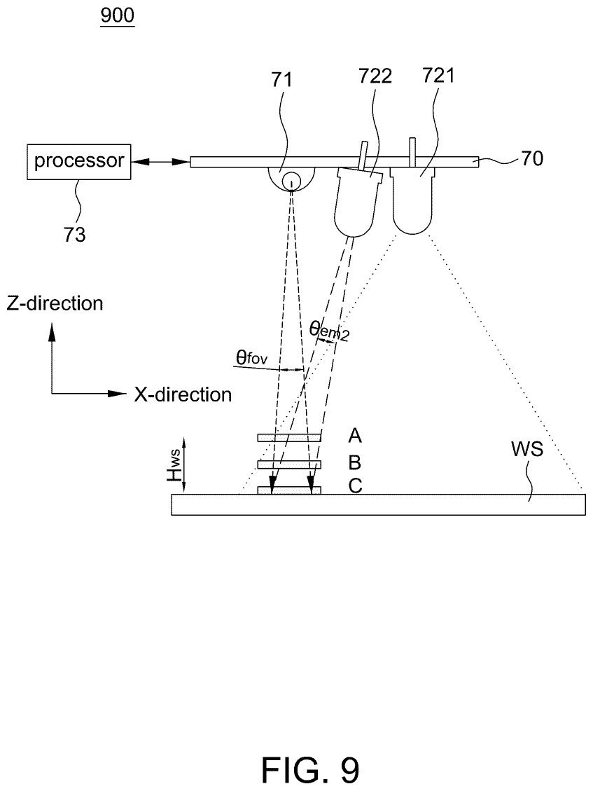

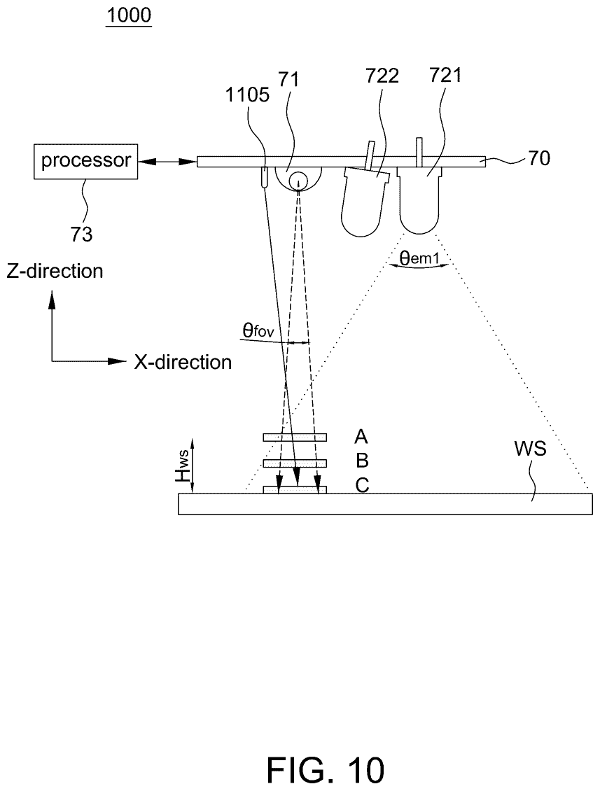

Please refer to FIG. 9, it is a schematic diagram of a cleaning robot 900 according to a fifth embodiment of the present disclosure.

The difference between the cleaning robot 900 and the cleaning robot 700 is that in the cleaning robot 900, the field of view θfov of the image sensor 71 is directed perpendicular to the working surface WS (e.g., in the Z-direction), and the second emission angle θem2 is tilted toward the image sensor 71 to cause the second emission angle θem2 to overlap with the field of view θfov of the image sensor 71 at different heights (e.g., A, B and C shown in FIG. 9) within the predetermined detectable range Hws by different cross sections, e.g., referring to FIG. 8.

In should be mentioned that although FIG. 9 shows that the first light source 721 and the second light source 722 are at the same side of the image sensor 71, and the second light source 722 is closer to the image sensor 71 than the first light source 721 in a tilted direction (e.g., X-direction or left-right direction in FIG. 9) of the second emission angle θem2 of the second light source 722, the present disclosure is not limited thereto. In another aspect, the first light source 721 and the second light source 722 may be arranged at different sides of the image sensor 71 as mentioned in the fourth embodiment.

The operations of the processor 73 in the fifth embodiment are similar to those of the fourth embodiment, e.g. including performing surface navigation according to first image frames captured by the image sensor 71 upon the first light source 721 emitting light, and identifying the working surface WS at different heights, due to the cleaning robot operating on different types of the working surface WS, according to a variation of a beam area (e.g., 722a shown in FIG. 8) in an image frame IF captured by the second image sensor 71 upon the second light source 722 emitting light.

Similarly, the first light source 721 and the second light source 722 emits light alternatively when both are LEDs. When the second light source 722 is a LD, the first light source 721 and the second light source 722 may emit light alternatively or simultaneously.

The conception of the present disclosure is that when the cleaning robot 700 or 900 is operating on different working surfaces, especially on a carpet, the hairs/fleeces of the carpet can enter the field of view θfov of the image sensor 71 such that the image sensor 71 detects the working surface WS at different heights, e.g., A, B and C shown in FIGS. 7A-7B and 9. For example, the processor 73 identifies the working surface WS as a carpet with long hairs when the working surface WS is identified to have the first height A; the processor 73 identifies the working surface WS as a carpet with short hairs when the working surface WS is identified to have the second height B; and identifies the working surface WS as a flat floor when the working surface WS is identified to have the third height C.

Accordingly, by detecting said different heights, the processor 71 is able to recognize a type of the working surface WS and generate a control signal to MCU of the cleaning robot 700 or 900 to control operations thereof, e.g., increasing/decreasing suction force, enable/disable mopping function according to different applications.

It should be mentioned that although the above embodiments are described in the way that only one of the field of view θfov and the second emission angle θem2 is tilted, the present disclosure is not limited thereto. In another aspect, both of the field of view θfov and the second emission angle θem2 are tilted to cause the second emission angle θem2 to overlap with the field of view θfov of the image sensor 71 by different cross sections at different heights (e.g., A, B and C shown in FIGS. 7A-7B and 9, but not limited to) within the predetermined detectable range Hws.

Please refer to FIG. 10, it is a schematic diagram of a cleaning robot 1000 according to a sixth embodiment of the present disclosure. The difference between the cleaning robot 1000 and the cleaning robot 900 is that the cleaning robot 1000 further includes a laser diode 1105 arranged on the substrate 70 and used to be turned on when an image quality of image frames captured by the image sensor 71 upon the first light source 721 emitting light is lower than a predetermined quality threshold.

That is, the first light source 721 having a wide emission angle is suitable to illuminate a rugged working surface. When the cleaning robot 1000 is operating on a working surface with high reflection, the processor 71 may not be able to acquire sufficient features from the captured image frames. In this case, the processor 71 controls the laser diode 1105 to turn on and controls the first light emitting diode 721 to turn off. The processor 73 performs the navigation function according to image frames captured when the laser diode 1105 is emitting light.

When an operating light source is the laser diode 1105, the processor 71 periodically turns on the first light source 721, and compares the image quality of an image frame captured when the first light source 721 is lighted with the predetermined quality or with the image quality of an image frame when the laser diode 1105 is lighted to determine whether to switch to use the first light source 721 to perform the surface navigation.

The function and operation of the second light source 722 in the sixth embodiment are identical to those mentioned in the fourth and fifth embodiments, i.e. for determining a type of the working surface WS, and thus details thereof are not repeated herein.

It should be mentioned that values, e.g., FOV, emission angles and heights, mentioned herein are only intended to illustrate but not to limit the present disclosure.

As mentioned above, to allow a cleaning robot to be able to perform different functions correctly, how to accurately recognize a type of working surfaces is an important requirement. However, the present ultrasonic means to recognize a working surface is not able to accurately distinguish a flat floor and a carpet with short hairs. In addition, there is still an issue that a carpet with long hairs cannot be recognized. Accordingly, the present disclosure further provides a cleaning robot (e.g., referring to FIGS. 1A-1B, 3 and 4A-4B) that uses a first optical detection path to distinguish a flat floor and a carpet with short hairs based on the dark field effect, and uses a second optical detection path to detect a carpet with long hairs and/or a length of carpet hairs to fulfill the requirement of recognizing a working surface of cleaning robots.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

1. A cleaning robot, configured to be operated on a working surface, and comprising:
an image sensor, having a field of view;
a first light source, configured to illuminate light with a first emission angle, which covers the whole of the field of view within a predetermined detectable range of the image sensor;
a second light source, configured to illuminate light with a second emission angle, which overlaps with the field of view of the image sensor by different cross sections at different heights in the predetermined detectable range; and
a processor, configured to recognize a type of the working surface according to a beam area of the second light source in an image frame captured by the image sensor,
wherein the field of view of the image sensor is tilted toward the second light source to cause the second emission angle to overlap with the field of view of the image sensor by different cross sections at the different heights.

2. The cleaning robot as claimed in claim 1, further comprising:
a substrate, on which the first light source, the second light source and the image sensor being arranged, and
the first light source and the second light source are at different sides of the image sensor.

3. The cleaning robot as claimed in claim 1, wherein the first light source and the second light source are configured to emit light alternatively.

4. The cleaning robot as claimed in claim 1, wherein the second emission angle is smaller than the first emission angle.

5. The cleaning robot as claimed in claim 1, wherein
the first light source is a light emitting diode, and
the second light source is another light emitting diode or a laser diode.

6. The cleaning robot as claimed in claim 1, wherein the processor is configured to
recognize a flat floor, a carpet with short hairs and a carpet with long hairs according to a gravity center position of the beam area in the image frame along a tilted direction of the field of view of the image sensor, or
recognize a flat floor, a carpet with short hairs and a carpet with long hairs according to a distance of the beam area from an edge of the image frame in a tilted direction of the field of view of the image sensor.

7. The cleaning robot as claimed in claim 1, wherein
the first light source and the second light source are at the same side of the image sensor, and
the first light source is closer to the image sensor than the second light source in a tilted direction of the field of view of the image sensor.

8. The cleaning robot as claimed in claim 1, wherein the processor is further configured to perform surface navigation according to image frames captured by the image sensor upon the first light source emitting the light.

9. The cleaning robot as claimed in claim 8, further comprising:
a laser diode, arranged on the substrate and configured to be turned on when an image quality of the image frames captured by the image sensor upon the first light source emitting the light is lower than a predetermined quality threshold.

10. A cleaning robot, configured to be operated on a working surface, and comprising:
an image sensor, having a field of view;
a first light source, configured to illuminate light with a first emission angle, which covers the whole of the field of view within a predetermined detectable range of the image sensor;
a second light source, configured to illuminate light with a second emission angle, which overlaps with the field of view of the image sensor at different heights in the predetermined detectable range by different cross sections; and
a processor, configured to recognize a type of the working surface according to a beam area of the second light source in an image frame captured by the image sensor,
wherein the field of view of the image sensor is directed perpendicular to the working surface, and the second emission angle is tilted toward the image sensor.

11. The cleaning robot as claimed in claim 10, further comprising:
a substrate, on which the first light source, the second light source and the image sensor being arranged, and
the first light source and the second light source are at different sides of the image sensor.

12. The cleaning robot as claimed in claim 10, wherein the first light source and the second light source are configured to emit light alternatively.

13. The cleaning robot as claimed in claim 10, wherein the second emission angle is smaller than the first emission angle.

14. The cleaning robot as claimed in claim 10, wherein
the first light source is a light emitting diode, and
the second light source is another light emitting diode or a laser diode.

15. The cleaning robot as claimed in claim 10, wherein the processor is configured to
recognize a flat floor, a carpet with short hairs and a carpet with long hairs according to a gravity center position of the beam area in the image frame along a tilted direction of the field of view of the image sensor, or
recognize a flat floor, a carpet with short hairs and a carpet with long hairs according to a distance of the beam area from an edge of the image frame in a tilted direction of the field of view of the image sensor.

16. The cleaning robot as claimed in claim 10, wherein
the first light source and the second light source are at the same side of the image sensor, and
the second light source is closer to the image sensor than the first light source in a tilted direction of the second emission angle of the second light source.

17. The cleaning robot as claimed in claim 10, wherein the processor is further configured to perform surface navigation according to image frames captured by the image sensor upon the first light source emitting the light.

18. The cleaning robot as claimed in claim 17, further comprising:
a laser diode, arranged on the substrate and configured to be turned on when an image quality of the image frames captured by the image sensor upon the first light source emitting the light is lower than a predetermined quality threshold.

19. A cleaning robot, configured to be operated on a working surface, and comprising:
an image sensor, having a field of view;
a first light source, configured to illuminate light with a first emission angle, which covers the whole of the field of view within a predetermined detectable range of the image sensor;
a second light source, configured to illuminate light with a second emission angle, which overlaps with the field of view of the image sensor by different cross sections at different heights in the predetermined detectable range; and
a processor, configured to
perform surface navigation according to first image frames captured by the image sensor upon the first light source emitting the light, and
identify the working surface at different heights, due to the cleaning robot operating on different types of the working surface, according to a variation of a beam area in an image frame captured by the second image sensor upon the second light source emitting the light.

20. The cleaning robot as claimed in claim 19, wherein the processor is configured to
identify the working surface as a carpet with long hairs upon the working surface being identified to have a first height,
identify the working surface as a carpet with short hairs upon the working surface being identified to have a second height,
identify the working surface as a flat floor upon the working surface being identified to have a third height, and
the first height is higher than the second height, and the second height is higher than the third height.
